(19) United States
(12) Patent Application Publication
(10) Pub. No.: US 2010/0237984 A1
(43) Pub. Date: Sep. 23, 2010

(54) Apparatus and Methods for Providing Access Control and Video Surveillance at Access Control Points

(76) Inventor: Christopher Zenaty, Forest Hills, NY (US)

Correspondence Address: LAW OFFICES OF MICHAEL L. WISE, LLC, 260 WALSH RD., LAGRANGEVILLE, NY, 12540, US

(21) Appl. No.: 12/407,124

(22) Filed: Mar. 19, 2009

(51) Int. Cl. G06F 7/04; H04N 7/18

(52) U.S. Cl. 340/5.2; 348/143

(57) ABSTRACT

An apparatus for providing access control and video surveillance at an access control point comprises an access control memory portion, a data processing portion, a camera input/output portion, and an event history memory portion. The access control memory portion is operative to store data indicative of who may properly enter past the access control point. The data processing portion controls who enters past the access control point in accordance with the data stored in the access control memory portion. The camera input/output portion is operative to receive data from a video camera. Finally, the event history memory portion is operative to store access data indicative of who entered past the access control point and to store video data generated by the video camera. The access control memory portion, the data processing portion, the camera input/output portion, and the event history memory portion are in signal communication with one another in the apparatus.

### FIELD OF THE INVENTION

The present invention relates generally to access control systems, and, more particularly, to apparatus and methods for providing access control and video surveillance at access control points.

### BACKGROUND OF THE INVENTION

Access control systems control the conditions under which a person may pass an access control point. An access control point may be door, turnstile, parking gate, elevator, or any other physical barrier where granting access can be electronically controlled.

With advances in the modern Information Technology (IT) infrastructure, consumers of access control systems have started to demand that these systems be integrated into their IT systems. Such integration provides several advantages to the consumer. For example, the consumer's already existing Internet Protocol (IP) network may provide the physical basis for the access control system, reducing the need to add additional wiring to the structure that needs to be secured (e.g., building or complex). Moreover, IP networks may provide interoperability of components over a wide area (even worldwide) rather than demanding only localized components. Finally, the IP infrastructure may eliminate the need to install proprietary, “fat client” software on the consumer's computers. Instead, open software architectures can be supported using thin-client software that is delivered via a web browser and developed by any one of several third-party security software developers.

FIG. 1 shows a relatively modern IP-based access control system 100. This system comprises a personal computer (PC) 105, a network video recorder (NVR) 110, and an IP controller 115 (also sometimes called a “master unit” or “hosting server”) that are connected to an Ethernet switch 120. An IP door node 125 is also connected to the Ethernet switch and, in this particular example, is tasked with directly controlling a reader 130, a lock 135, and a request-for-exit (REX) device 140 at a door 145 (i.e., an access control point). Notably, the IP controller houses the application logic and data storage for the door node. In other words, the door node itself has no or very limited memory and processing capabilities and therefore relies on the IP controller to make access decisions and to store a log of access events. Consequently, if this connection is lost, door access is reduced to some degraded condition such as always open or always locked, and no access events are logged. The IP controller may be programmed and monitored via a web browser on the PC in combination with a web server on the IP controller.

The access control system 100 also comprises an IP video camera 150 responsible for video surveillance of the door 145. Data from the IP video camera is directed to the Ethernet switch 120, where it is further disseminated to the NVR 110 to be processed and stored. The IP video camera, therefore, is not integrated into the IP door node 125 and does not come under the control of the IP controller 115. Instead, it is treated as entirely distinct node on the Ethernet network and requires a separate NVR 110 and separate programming via the PC 105. Accordingly, separate Ethernet cabling (e.g., category 5 (Cat5) cable) must be provided from the Ethernet switch to the IP video camera. Moreover, if a user wants to correlate the access log data from the IP door node with video data from the IP video camera, the PC (or other user system) must acquire access event data from the IP controller and the video data from the NVR. This typically requires that the PC be programmed to handle data in several different protocols, some of them being proprietary. Unfortunately, all of this programming and system integration is frequently costly and time consuming.

Accordingly, existing access control systems have several deficiencies including, but not limited to, inefficiencies in wiring, hardware, and programming; severely degraded function when the network is disrupted; and separately handled access event data and video data. There is, as a result, a need for novel access control apparatus and methods that address these various deficiencies.

### SUMMARY OF THE INVENTION

Embodiments of the present invention address the above-identified need by setting forth apparatus and methods for providing access control and video surveillance at access control points in a manner that addresses some of the deficiencies of existing access control systems.

In accordance with an aspect of the invention, an apparatus for providing access control and video surveillance at an access control point comprises an access control memory portion, a data processing portion, a camera input/output portion, and an event history memory portion. The access control memory portion is operative to store data indicative of who may properly enter past the access control point. The data processing portion controls who enters past the access control point in accordance with the data stored in the access control memory portion. The camera input/output portion is operative to receive data from a video camera. Finally, the event history memory portion is operative to store access data indicative of who entered past the access control point and to store video data generated by the video camera. The access control memory portion, the data processing portion, the camera input/output portion, and the event history memory portion are in signal communication with one another in the apparatus.

In accordance with another aspect of the invention, a method of providing access control and video surveillance at an access control point utilizes an apparatus comprising an access control memory portion, a data processing portion, a camera input/output portion, and an event history memory portion. Data indicative of who may properly enter past the access control point is stored in the access control memory portion. The data processing portion then controls who enters past the access control point in accordance with the data stored in the access control memory portion. A video camera sends data to the camera input/output portion. Finally, data indicative of who entered past the access control point and data generated by the video camera is stored in the event history memory portion.

In accordance with one of the above-identified embodiments of the invention, a door unit is tasked with controlling entry and egress at a door, and is also tasked with providing video surveillance of these entry and egress events. The door unit comprises a data processing unit and system memory that allow it to independently determine who may pass through the door and to store data (“access event data”) indicative of these events. In addition, the door unit comprises an interface to an IP video camera. In doing so, the door unit is also able to store video data that shows the access events at the door in the same memory as the access event data. Network adapter circuitry and software also allow the door unit to act as a web server. Client computers can program the door unit and download its access event and video data via an IP network.

Advantageously, the above-described embodiment provides greater efficiency in wiring, hardware, and programming; improved functionality when the network is disrupted; and improved handling of access event data and video data when compared to conventional access control system.

These and other features and advantages of the present invention will become apparent from the following detailed description which is to be read in conjunction with the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows a block diagram of a conventional IP access control system;

FIG. 2 shows a block diagram of an access control system in accordance with an illustrative embodiment of the invention;

FIG. 3 shows a block diagram of the FIG. 2 door unit;

FIG. 4 shows an illustrative method of operating the FIG. 2 door unit to allow entry past a door; and

FIG. 5 shows an illustrative method of operating the FIG. 2 door unit to allow egress past a door.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

FIG. 2 shows a block diagram of an access control and video surveillance system (ACVSS) 200 in accordance with an illustrative embodiment of the invention. The ACVSS comprises a PC 205, an Ethernet switch 210, a Power-over-Ethernet (PoE) injector 215, and an uninterruptible power supply (UPS) 220, which are interconnected in the manner shown. A door unit 225 is connected to the Ethernet switch through the PoE injector. The door unit is tasked with controlling entry and egress at a door 230, and is also tasked with providing video surveillance of these entry and egress events. To do so, the door unit is further connected to a reader 235, a lock 240, a door contact 245, a REX device 2505, and a video camera 255, which are each located substantially proximate to the door.

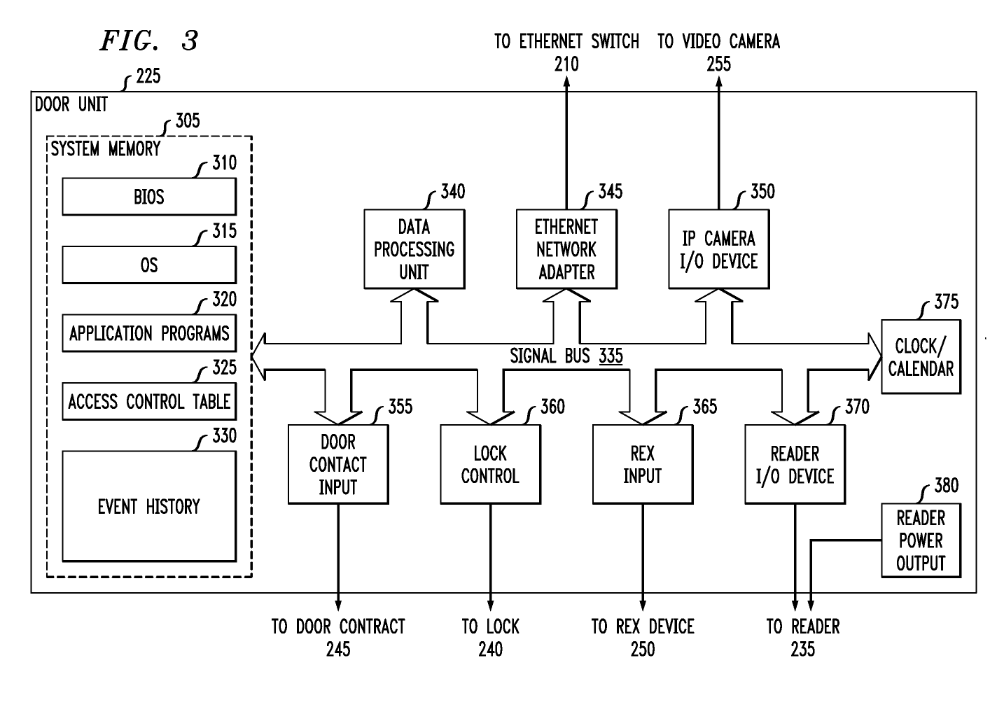

The block diagram in FIG. 3 shows additional aspects of the door unit 225. The illustrative door unit comprises a system memory 305 which, in turn, comprises a Basic Input/Output (I/O) System (BIOS) portion 310, an operating system (OS) portion 315, an application programs portion 320, an access control table portion 325, and an event history portion 330. A signal bus 335 connects the system memory to a data processing unit 340, an Ethernet network adapter 345, an IP camera I/O device 350, a door contact input 355, a lock control 360, a REX input 365, a reader I/O device 370, and a clock/calendar 375. The door unit also comprises a reader power output 380.

As indicated in FIG. 3, the Ethernet network adapter 345 in the door unit 225 is connected to the Ethernet switch 210 (after traversing the PoE injector 215). The Ethernet network adapter is supported by software device drivers stored in the door unit's system memory 305 and executed by the data processing unit 340 in conjunction with the operating system. When operational, the Ethernet network adapter allows the door unit to interface with the Ethernet switch in order to form an Ethernet-based local area network (LAN). As is conventional in Ethernet LANs, communication is achieved by using a communication protocol in accordance with the Internet Protocol Suite (also sometimes called “TCP/IP”). Ethernet network adapters (also sometimes called “network interface cards” (NICs)) of the type described herein are conventional. As a result, their design and function will be familiar to one skilled in the art. Moreover, they are described in some detail in R. Seifert et al., “The All-New Switch Book: The Complete Guide to LAN Switching Technology,” Wiley, 2008, which is hereby incorporated by reference herein.

The PC 205, in contrast, may be part of the same Ethernet LAN as the door unit 225, or, alternatively, may be physically removed from that LAN and communicate with it over a wide area network (WAN) such as the Internet. In this manner, the door unit and the PC each become nodes in a larger IP network. Like the Ethernet network card 345, the PC and Ethernet switch 210 may be entirely conventional IP devices, aiding in the ease and cost of their implementation. The PC may, for example, be any general or purpose-built computer capable of using a web browser and communicating through an IP network. The Ethernet switch may, as just one example, be obtained from D-link® of Fountain Valley, Calif., USA.

The door unit 225 may be connected to the PoE injector 215 and Ethernet switch 210 via conventional Cat5 or similar twisted pair cabling. Advantageously, placing the PoE injector in-line between the Ethernet switch and the door unit as shown in FIG. 2 allows the PoE injector to provide all or some of the electrical power required to run the door unit over the same cabling (e.g., Cat5 cabling) used to provide data communications in the Ethernet LAN. This reduces the need to provide a separate power supply for the door unit, although this still remains an option. Presently, PoE is typically practiced in accordance with the Institute of Electrical and Electronic Engineers (IEEE) 802.3af power standard (which is hereby incorporated by reference herein), although other standards, some with greater power capabilities, are also currently being developed and would also fall under the scope of the invention. Moreover, some Ethernet switches come integrated with a PoE power source and, as a result, do not require the use of a discrete PoE injector device. PoE injectors and Ethernet switches with built-in PoE capabilities are also commercially available from, for example, D-Link® (cited above).

The UPS 220 provides backup power to the Ethernet switch 210 and the PoE injector 215. This configuration allows these elements, as well as those elements receiving power from the PoE injector (e.g., the door unit 225) to continue functioning in case of a loss in primary power.

Now referring again to the details of the door unit 225 shown in FIG. 3, the system memory 305 may comprise volatile memory (e.g., dynamic random-access memory (DRAM) and static random-access memory (SRAM)), non-volatile memory (e.g., read-only memory (ROM), flash memory, magnetic disks, magnetic tapes, and optical discs), or a combination thereof. Accordingly, the system memory may comprise one single device or a plurality of devices. The access control table portion 325 of the memory is operative to store data indicative of who may properly enter past the door 230. It may further limit access based on time of day as well as other variables. In the present embodiment, this data is stored in a table format (the “access control table”) which correlates people and their credentials with their respective access privileges. Nevertheless, non-table formats of storing this type of information may also be utilized (e.g., those using algorithms instead of tables). The event history portion 330 of the system memory, in turn, is operative to store access event data indicative of who entered past the door and when the door was opened for egress. It is also operative to store surveillance video data generated by the video camera 255.

The application programs 320 allow the door unit 225 to act as a web server. This means that the door unit is capable of receiving conventional Hypertext Transfer Protocol (HTTP) requests from a client computer and providing a HTTP response to that computer. These communications, in turn, allow the uploading and downloading of documents, application programs, and raw data to and from the door unit. In this manner, the PC 205 may be used to conveniently provide application program updates and access control table updates to the door unit over the IP network. In addition, the PC may periodically download the access event data and video data stored in the door unit's event history memory portion 330. In fact, the manufacturer of the door unit may, if it wishes, make Application Programming Interfaces (APIs) and Software Development Kits (SDKs) available to third party software developers so that these developers are encouraged to make state of the art thin-client applications that facilitate and leverage upon these particular upload/download capabilities.

Web servers are widely implemented in computers and computer-like devices and thus their implementation in the door unit 225 with its data processing unit 340, system memory 305, and Ethernet network adapter 345 will be familiar to one skilled in the art. Web servers are, for example, already implemented in the security system art in IP controllers and IP video cameras. Details of configuring a web server are also provided in L. Shklar et al., “Web Application Architecture: Principles, Protocols and Practices,” Wiley, 2003, which is hereby incorporated by reference herein.

The door contact input 355, lock control 360, REX input 365, reader I/O device 370, and reader power output 380 work in a manner that will also be familiar to those skilled in the art. The door contact monitors the condition of the door 230, more particularly, whether the door is open or closed. It does so by monitoring the door contact 245 (e.g., a magnetic door contact). The lock control, in turn, controls the lock 240 on the door. The lock may, for example, be an electric strike or an electromagnetic lock (both commonly utilized for access control at doors). The REX input is connected to the REX device 250. It receives a signal from the REX device when someone wishes to exit past the door. Conventional REX devices comprise manual pushbuttons and motion sensors. Finally, the reader I/O device interfaces with the reader 235. The reader is tasked with receiving the credentials of those wishing to enter past the door. Conventional readers are available from Suprema, Inc. of Gyeonggi, Korea. Power (e.g., 12 Volts) is provided to the reader via the reader power output.

In accordance with an aspect of the invention, the video camera 255 is an IP video camera, meaning that it contains those components (e.g., a network adapter) that allow it to form a node on an IP network in a manner similar to the door unit 225. The video camera may, for example, be acquired from Axis Communications® of Lund, Sweden as well as from several other commercial vendors. Notably, however, the video camera sends data back and forth to the door unit (via the IP camera I/O device 350) in the AVCSS 200 rather than communicating directly with an Ethernet switch 210. The video camera is, in turn, controlled through the IP camera I/O device via device driver software stored in the operating system portion 315 of the system memory 305 and executed by the data processing unit 340. There is not a need for a separate NVR.

Furthermore, the video camera 255 also preferably receives its power from the door unit 225 using PoE technology. This allows the video camera to be connected to the door unit using a single cable for both data and power. It may, for example, be connected to the door unit using another Cat5 or similar twisted pair cable. There is, as a result, no need to run separate cabling from the video camera back to the Ethernet switch 210, nor is there a need to provide the video camera with its own source of power (although this remains an option). Accordingly, substantial wiring efficiency improvements and cost savings may also be achieved by implementing an apparatus in accordance with aspects of the invention.

In addition, for further compactness and efficiency, the components of the door unit 225 shown in FIG. 3 may be implemented on a single printed circuit board.

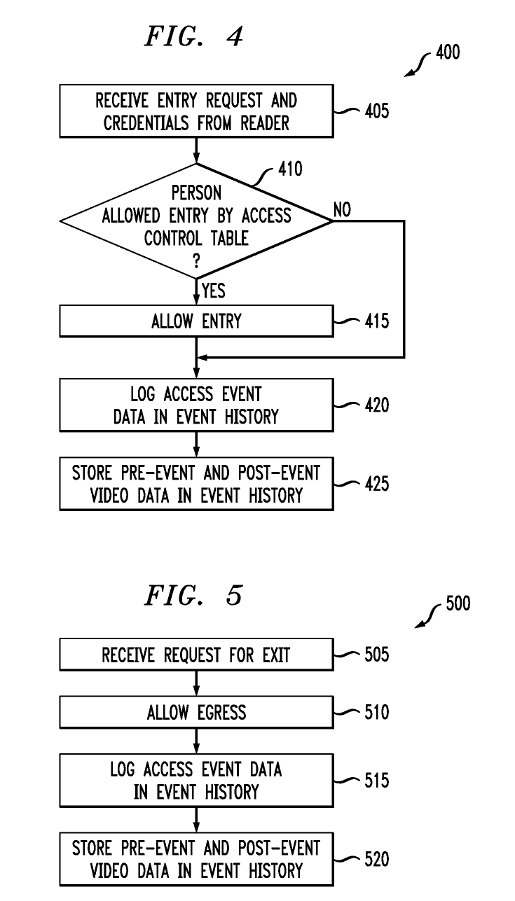

FIGS. 4 and 5 show flow charts of how the above-described AVCSS 200 may perform entry and egress functions using the above described components. More particularly, FIG. 4 shows an illustrative method 400 of operating the door unit 225 to allow entry past the door 230. In step 405, the door unit receives an entry request from the reader 235 along with the credentials provided by the person wishing to enter (the “requesting person”). The reader may, for example, comprise a keyboard for personal identification numbers (PINs), a magnetic card reader for access badges or passcards, a biometric sensor such as a fingerprint scanner or a retina scanner, or some combination thereof. In step 410, the data processing unit 340 compares these credentials with the data stored in the access control table stored in the access control table memory portion 325. If the access control table indicates that the credentials (e.g., fingerprints) belong to a person that is allowed to enter at that particular time, the door unit proceeds to step 415. If not, it continues to step 420.

If the credentials allow entry, the data processing unit 340 allows the requesting person to enter the door 230 in step 415. It does so by having the lock control 360 open the lock 240. The lock may, for example, be opened for a first predetermined period of time (e.g., 15 seconds), thereby giving the requesting person sufficient time to manually open the door with the door unlocked. The door unit 225 may further monitor the door contact input 245 in order to determine that the door is in fact opened and that the door is closed within a second predetermined time after the entry is allowed (e.g., 30 seconds). This makes sure that the door does not get left ajar with the possible effect of allowing entry by unauthorized persons. In case the door unit detects an extended door ajar condition, it can proceed to sound an alarm and contact the host PC 205.

Step 420 comprises the logging of the access event data in the event history portion 330 of the system memory 305. As indicated by the flow chart, the logging occurs every time someone attempts entry, whether physical entry is actually allowed or not. The access event data may include information reflecting the submitted credentials, the time and date of the attempt (from the clock/calendar 375), whether entry was allowed, as well as any other descriptive information that the user wishes to save.

Subsequently, in step 425, the “pre-event” and “post-event” video data from the video camera 255 is also stored in the event history portion 330 of the system memory 305. The pre-event video data visually shows what occurs during a first predetermined time (e.g., 30 seconds) prior to the entry event. It might, for example, show the requesting person approaching the door 230 and inputting that person's credentials into the reader 235. The post-event video data shows what occurs during a second predetermined time (e.g., another 30 seconds) after the credentials are read. It might show, for example, the requesting person passing through the door or the reaction of that person to being denied access. The storing of only a finite amount of video data for each access event reduces the amount of video data that must be stored in the door unit's system memory. Preferably, the saved video data is tagged with the time and date of its recording (as provided by the clock/calendar 375). It may also be further tagged with the credentials of the requesting person. These tags allow the video data to be readily associated with the access event data that is also stored in the event history memory portion if, for some reason, an entry event is associated with a mishap or an unauthorized activity.

FIG. 5 goes on to show an illustrative method 500 of operating the door unit 225 to allow egress past the door 230. In step 505, the REX input 365 of the door unit receives a request for exit from the REX device 250. With a signal that someone wishes to egress past the door, the data processing unit 340 responds by having the lock control 360 unlock the door and allow egress in step 510. Like an entry event, the door may be unlocked for only a finite amount of time and the door contact 245 may be monitored to confirm that the door is opened and fully closed. Subsequently, in steps 515 and 520, the door unit logs the access event data reflecting the egress event and stores the associated pre-event and post-event video data in the event history memory portion 330. Again, this data can be used for forensic purposes at a later time.

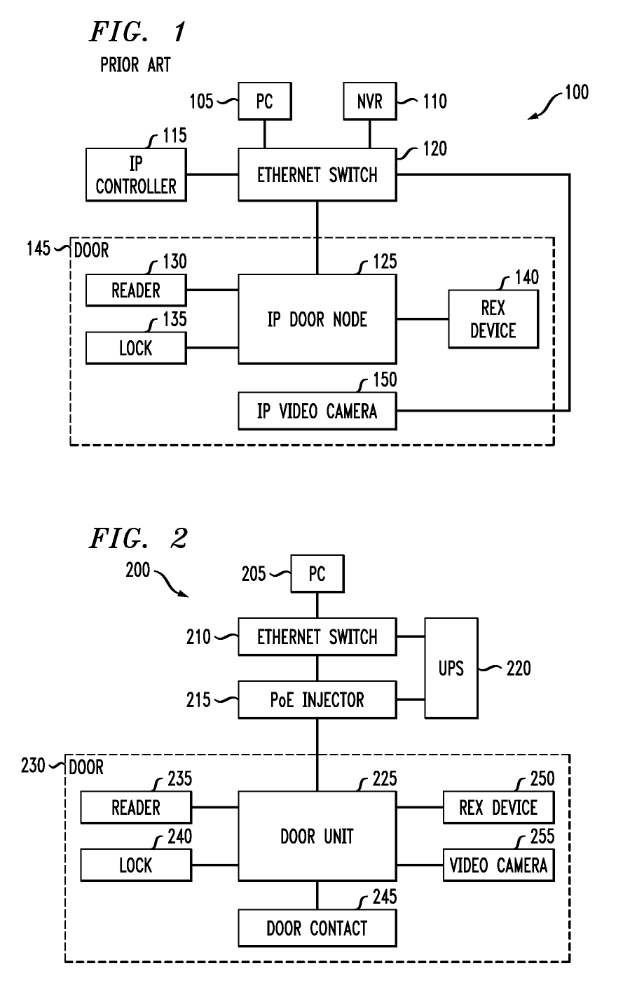

FIGS. 4 and 5 highlight additional advantages of the AVCSS 200. Notably, the door unit 225 itself comprises those components required to make a decision on who may enter past the door 230 as well as those components necessary to store the access event data and video data for both entry and egress events. Accordingly, the door unit may remain fully functional in performing these tasks even if its connection to its IP network is disrupted. For this reason, the AVCSS is substantially more robust than conventional access control systems that utilize distributed components to achieve both decision-making and data storage functions (e.g., the FIG. 1 access control system 100).

It should again be emphasized that the above-described embodiments of the invention are intended to be illustrative only. Other embodiments can use different types and arrangements of elements or different method steps for implementing the described functionality. For example, a door unit in accordance with aspects of the invention might service a plurality of access control points and surveillance video cameras rather than just a single access control point and a single surveillance video camera as described above. These numerous alternative embodiments within the scope of the appended claims will be apparent to one skilled in the art.

What is more, all the features disclosed herein may be replaced by alternative features serving the same, equivalent, or similar purpose, unless expressly stated otherwise. Thus, unless expressly stated otherwise, each features disclosed is one example only of a generic series of equivalent or similar features.

What is claimed is:

1. An apparatus for providing access control and video surveillance at an access control point, the apparatus comprising:
an access control memory portion, the access control memory portion operative to store data indicative of who may properly enter past the access control point;
a data processing portion, the data processing portion operative to control who enters past the access control point in accordance with the data stored in the access control memory portion;
a camera input/output portion, the camera input/output portion operative to receive data from a video camera; and
an event history memory portion, the event history memory portion operative to store access event data indicative of who entered past the access control point and to store video data generated by the video camera;
wherein the access control memory portion, the data processing portion, the camera input/output portion, and the event history memory portion are in signal communication with one another in the apparatus.

2. The apparatus of claim 1, wherein the video camera comprises an internet protocol video camera.

3. The apparatus of claim 1, wherein the apparatus is located substantially proximate to the access control point.

4. The apparatus of claim 1, wherein the data processing portion allows egress past the access control point based on a signal from a request-for-exit device.

5. The apparatus of claim 1, wherein the video camera is connected to the apparatus solely by a single cable.

6. The apparatus of claim 1, wherein the apparatus is further operative to supply power to the video camera.

7. The apparatus of claim 6, wherein the power is supplied to the video camera at least in part by Power over Ethernet.

8. The apparatus of claim 1, wherein the apparatus is at least in part powered by Power over Ethernet.

9. The apparatus of claim 1, wherein video data stored in the event history memory portion is tagged with at least one of a time and a date the video data was collected.

10. The apparatus of claim 1, wherein the data processing portion controls entry at the access control point at least in part in response to a signal from a reader.

11. The apparatus of claim 10, wherein the apparatus supplies power to the reader.

12. The apparatus of claim 1, wherein the data processing portion controls a lock.

13. The apparatus of claim 1, wherein the apparatus is adapted to be connected to an Ethernet network.

14. The apparatus of claim 1, wherein the apparatus is operative to communicate data to other devices using the Internet Protocol Suite.

15. The apparatus of claim 1, wherein the apparatus is operative to function as a web server.

16. The apparatus of claim 15, wherein the web server allows the access control memory portion to be remotely programmed.

17. The apparatus of claim 15, wherein the web server allows data in the event history memory portion to be remotely accessed.

18. The apparatus of claim 1, wherein the access control memory portion, the data processing portion, the camera input/output portion, and the event history are wholly implemented on a single printed circuit board.

19. A structure comprising an apparatus for providing access control and video surveillance at an access control point, the apparatus comprising:
an access control memory portion, the access control memory portion operative to store data indicative of who may properly enter past the access control point;
a data processing portion, the data processing portion operative to control who enters past the access control point in accordance with the data stored in the access control memory portion;
a camera input/output portion, the camera input/output portion operative to receive data from a video camera; and
an event history memory portion, the event history memory portion operative to store access event data indicative of who entered past the access control point and to store video data generated by the video camera;
wherein the access control memory portion, the data processing portion, the camera input/output portion, and the event history memory portion are in signal communication with one another in the apparatus.

20. A method of providing access control and video surveillance at an access control point, the method utilizing an apparatus comprising an access control memory portion, a data processing portion, a camera input/output portion, and an event history memory portion, wherein the method comprises the steps of:
causing data indicative of who may properly enter past the access control point to be stored in the access control memory portion;
causing the data processing portion to control who enters past the access control point in accordance with the data stored in the access control memory portion;
causing a video camera to send data to the camera input/output portion; and
causing data indicative of who entered past the access control point and data generated by the video camera to be stored in the event history memory portion.
